(19) United States
(12) Patent Application Publication
(10) Pub. No.: US 2026/0110869 A1
(43) Pub. Date: Apr. 23, 2026

(54) LADDER AND BASKET MOUNTED PANEL

(71) Applicant: viaPhoton, Inc.., Aurora, IL (US)

(72) Inventors: Yihan ZHANG, Aurora, IL (US); Mark VAN DEN AVONT, Aurora, IL (US); Walter Mark HENDRIX, Dallas, TX (US); Mark James SMRHA, Chicago, IL (US); Jeffrey Earl JONES, SR., Stewartstown, PA (US)

(21) Appl. No.: 19/364,993

(22) Filed: Oct. 21, 2025

Related U.S. Application Data
(60) Provisional application No. 63/710,529, filed on Oct. 22, 2024.

(51) Int. Cl. G02B 6/44

(52) U.S. Cl. CPC G02B 6/4459

(57) ABSTRACT

An apparatus, system, and method are disclosed for mounting a fiber-optic panel assembly to a cable conveyance. The panel assembly includes a bracket tray coupled to the conveyance and a panel body coupled to the bracket tray. A plurality of mounting attachments secure the panel assembly to the conveyance while maintaining a substantially perpendicular orientation of the panel assembly relative to the conveyance. The system supports multiple installation geometries, enabling the panel assembly to be mounted beneath or alongside the conveyance.

This Application claims the benefit of U.S. Provisional Application Ser. No. 63/710,529, filed Oct. 22, 2024, which is hereby incorporated by reference for all purposes.

### BACKGROUND

Equipment racks in data centers and telecommunication rooms are used for housing various rack-mounted panels and equipment. Network equipment is installed inside the available rack spaces. Data center infrastructure must be carefully managed to optimize the use of available rack space while accommodating an increasing density of fiber connections. As networks expand, there is a need to manage more cables and connectors within the same physical footprint, which can lead to congestion, difficult cable routing, and limited scalability.

Conventional fiber management systems typically include fixed brackets or mounts that are installed during the initial setup of a data center. While effective, these systems can pose difficulties when additional cables need to be integrated or when existing cables require rerouting. The rigid structure of traditional solutions may lead to increased labor costs and downtime, as technicians must navigate around pre-existing installations or make adjustments to fixed pathways. Furthermore, the inability to easily modify cable routes can restrict the scalability of data center operations, potentially leading to inefficiencies and underutilized infrastructure.

### SUMMARY

The present disclosure relates to mounting systems for fiber-optic panels and, more particularly, to a panel assembly that can be mounted directly to a cable conveyance such as a ladder rack or basket tray using adjustable attachments. The disclosed designs provide installation flexibility, mechanical stability, and controlled cable management in data center and telecommunication environments.

In one aspect, an apparatus is provided that includes a panel assembly configured to support one or more fiber-optic modules. The panel assembly is coupled to a cable conveyance through a plurality of mounting attachments that maintain a substantially perpendicular orientation of the panel assembly relative to the cable conveyance. In certain embodiments, the panel assembly includes a bracket tray that couples to the cable conveyance and a panel body that couples to the bracket tray. The panel body includes multiple module openings configured to receive fiber-optic connector modules or adapter plates. Each mounting attachment may be slidable along a corresponding diagonal slot in the bracket tray, enabling symmetrical or asymmetrical placement along the panel assembly. The mounting attachments may include hooks, clips, or clamps configured to engage a rung or rail of a ladder rack, or spacers or standoffs configured to couple the panel assembly to one or more wire members of a basket tray. Each mounting attachment may include a single-bolt fastener that permits rotation or positional adjustment within a diagonal slot. A strain-relief feature may be coupled to an edge of the panel assembly to guide and support fiber cables exiting the panel body.

In another aspect, a cable-management system is provided that includes a cable conveyance configured to route a plurality of fiber-optic cables and a panel assembly mounted to the cable conveyance through a plurality of mounting attachments. The bracket tray and panel body are configured to support fiber-optic modules while enabling flexible installation beneath or alongside the cable conveyance. The mounting attachments are repositionable along diagonal slots to accommodate various installation geometries, allowing for mechanical stability and balanced support during use. The system may include configurations adapted for ladder racks or basket trays and may incorporate strain-relief features to maintain proper bend-radius control of the fiber-optic cables.

In yet another aspect, a method for installing a panel assembly to a cable conveyance is provided. The method includes positioning the panel assembly adjacent to the cable conveyance, coupling the panel assembly using a plurality of mounting attachments, and maintaining a perpendicular orientation of the panel assembly relative to the cable conveyance. The method may further include sliding each mounting attachment along a diagonal slot of the bracket tray to position the panel assembly symmetrically or asymmetrically, engaging the attachments with rails or rungs of a ladder rack or with wire members of a basket tray, and adjusting the position or angle of the panel assembly by rotating one or more attachments. A strain-relief feature may be attached to the panel assembly to manage cable routing and maintain the bend radius of the exiting fiber cables.

Other aspects of one or more embodiments will be apparent from the following description and the appended claims.

### BRIEF DESCRIPTION OF DRAWINGS

FIG. 1 is an environmental view showing a rack and a cable conveyance in accordance with one or more embodiments of the disclosure.

FIGS. 2A and 2B illustrates a panel in accordance with one or more embodiments.

FIG. 3 is a perspective view of a panel assembly secured to the bracket tray.

FIG. 4 is a view showing a secured to a cable conveyance in accordance with one or more embodiments.

FIG. 5 is a view showing a bracket tray and associated attachments in accordance with one or more embodiments.

FIGS. 6A and 6B are views illustrating alternative attachment configurations for coupling the panel assembly to different types of cable conveyances in accordance with one or more embodiments.

Like elements in the various figures are denoted by like reference numerals for consistency.

### DETAILED DESCRIPTION

The present disclosure introduces a mounting system for fiber-optic panel assemblies that expands the available installation locations within crowded data centers and telecommunications environments. Unlike conventional systems that rely on fixed rack spaces, the disclosed invention allows a panel assembly to be mounted directly to existing cable conveyances, such as ladder racks or basket trays, using adjustable attachments and a bracket tray with diagonal slot geometry. This configuration enables the use of previously unused space above or alongside equipment racks, increasing the number of available mounting positions without modifying the underlying infrastructure.

The disclosed system further provides a mounting architecture that maintains a perpendicular orientation of the panel assembly relative to the cable conveyance while allowing lateral and diagonal adjustment along the conveyance. The bracket tray supports sliding attachments that can be positioned within elongated slots to accommodate variable mounting patterns, equipment spacing, or cable pathways. By utilizing interchangeable attachments—such as hooks or clamps for ladder racks and spacers or standoffs for basket trays—the same panel assembly can be deployed across multiple conveyance types. This adaptability allows the network operator to install fiber panels in areas that would otherwise remain inaccessible or underutilized, improving spatial efficiency within congested cable environments.

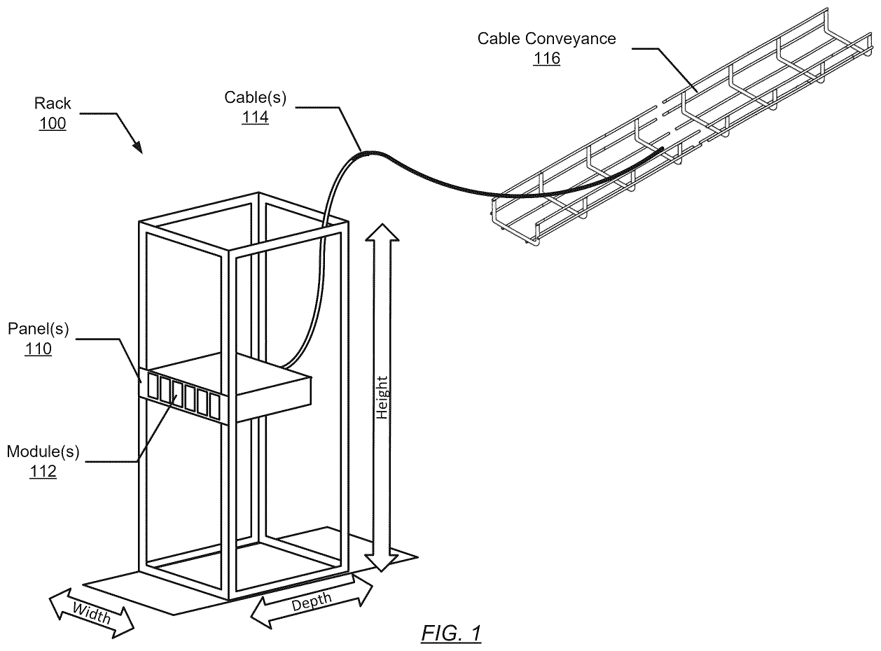

Turning to FIG. 1, a rack is shown in accordance with one or more embodiments. The rack (100) is a piece of telecommunications equipment that provides for the housing and organization of diverse telecommunication devices.

The outer dimensions of rack (100) conform with most network and server equipment. For example, rack width may measure 19 inches (48.26 cm) or 23 inches (58.42 cm) in width, standard measurements that are adhered to in the telecommunications industry. Other dimensions may be used, e.g., 21 inches, 23 inches, etc. The dimensions ensure that the rack can accommodate equipment with different form factors, such as 1U, 2U, or larger units, where “U” represents a standard rack unit of measure equal to 1.75 inches in height.

The rack (100) may include a series of uniformly spaced vertical mounting slots, located on both the front and rear, to facilitate the arrangement and mounting of various telecommunication devices and components. The slots serve as attachment points for mounting the panel(s) (110). The rack (100) may further be equipped with additional features such as ventilation openings and cable management.

Panel(s) (110) are components that mount within the rack (100) to organize, secure, and provide access to connective hardware. The panel may be constructed from materials such as steel or aluminum that can support the weight of the modules and withstand the physical demands of a data center environment.

Panel(s) (110) are formed with standardized form factors for compatibility with the mounting slots of the rack (100). For example, panel(s) (110) may include standardized mounting points to align with rack units, a layout that supports the intended cable or connector density, and provisions for labeling and user accessibility.

The panel(s) (110) may be equipped with one or more module(s) (112) to secure the fibers using ports, connector adapters, connectors, etc. Module(s) (112) are prefabricated units or sub-assemblies designed for quick installation into the rack (100). The module(s) (112) may include electronic components and/or optical components, such as optical connectors, optical fibers, switches, routers, or patches. The module(s) (112) may include features for splicing, cable management, and security.

Each module(s) (112) is designed to contain a specific number of optical connectors, optimizing space utilization within the rack mount to support high fiber densities. For example, each module(s) (112) may support fiber densities of 144 fibers, 288 fibers, and/or 576 fibers per module, as well as other suitable densities. The connectors may be an industry-standard connector such as a standard connector (SC), Lucent connector (LC), or Multi-fiber Termination Push-on connector (MTP), depending on the network requirements.

The module(s) (112) may have multiple widths, such that a varying number of modules may be housed within the panel(s) (110). The module(s) (112) may be sized to fit twelve (12) modules in the panel(s) (110), however other sizes—e.g., 2, 3, 4, 6, 8—are also contemplated. When fully loaded with module(s) (112), the panel(s) (110) support fiber densities of 1728 fibers, 3456, fibers, and/or 6912 fibers per panel, as well as other suitable densities.

Cable(s) (114) may be fiber optic cables that carry data signals between different network devices and components. Cable(s) (114) are routed through the data center infrastructure, connecting panels, modules, and external devices. For example, cable(s) (114) may interconnect module(s) (112). Cable(s) (114) may include a core, cladding, and protective coating, which ensure the integrity of the data signal. Cable(s) (114) can be single-mode or multi-mode, depending on the network requirements. Cable(s) (114) may be color-coded to facilitate identification during installation and maintenance.

Cable conveyance (116) is a support system used to route and support telecommunications and other optical fiber cable. The tray is mounted overhead or along the walls, providing an organized pathway for cables, preventing tangling, and reducing the risk of damage. Cable trays may be equipped with side walls or barriers to constrain a cable's horizontal placement or movement. Cable trays are made from metal or reinforced plastic and are designed to accommodate the weight and volume of multiple cables. Slots or openings in the tray allow for cable entry and exit at various points. Cable trays may include modular segments that can be extended or adjusted to match the infrastructure layout.

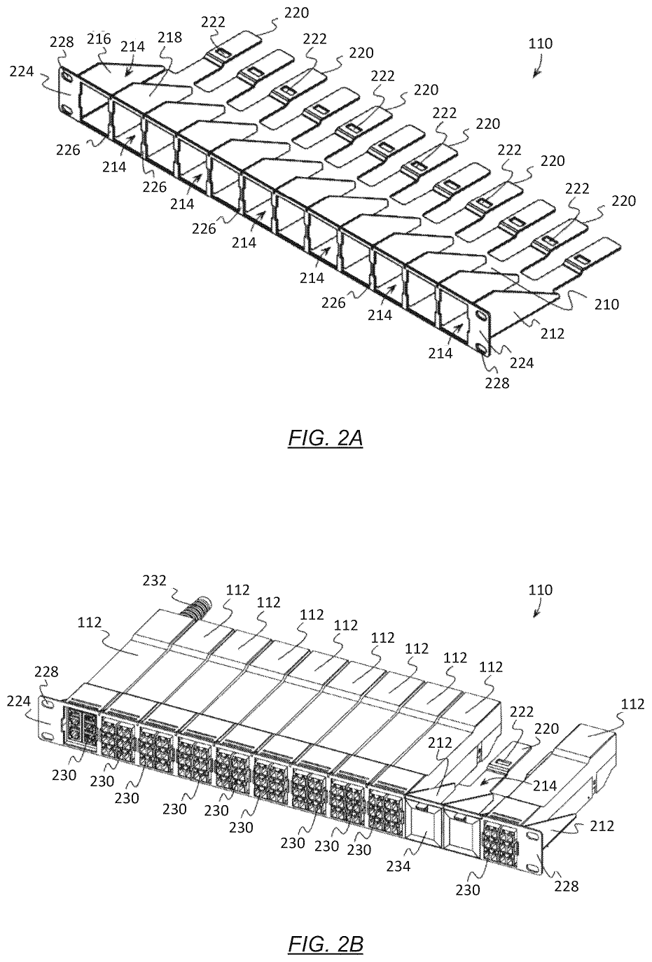

FIGS. 2A and 2B illustrate an example of a panel equipped with one or more modules, according to various embodiments. The panel and modules are panel(s) (110) and module(s) (112) of FIG. 1.

The panel(s) (110) may comprise a frame base (210) to which two or more dividers (212) may be coupled. Preferably, the frame base (210) and the dividers (212) may each be generally planar or flat in shape. The dividers (212) may be oriented generally perpendicular to the frame base (210). Optionally, two or more of the dividers (212) may be oriented generally parallel to each other, and preferably each of the dividers (212) of a panel(s) (110) may be oriented generally parallel to each other. The elements of the panel(s) (110) may be made from or may comprise durable materials such as various types of stamped sheet metal, plastics, carbon fiber, or any other generally rigid material.

An alignment slot (214) may be formed and bounded by two adjacent dividers (212), such as a first divider (216) and a second divider (218), and by portions of the frame base (210) extending between the two adjacent dividers (212). For example, thirteen dividers (212) may be coupled to a frame base (210) to form twelve alignment slot (214). In some embodiments, a first divider (216) and second divider (218) may be separated by a distance that is slightly greater than the width of the module(s) (112) so that the module(s) (112) may be snugly or received in the alignment slot (214) between the two adjacent dividers (212).

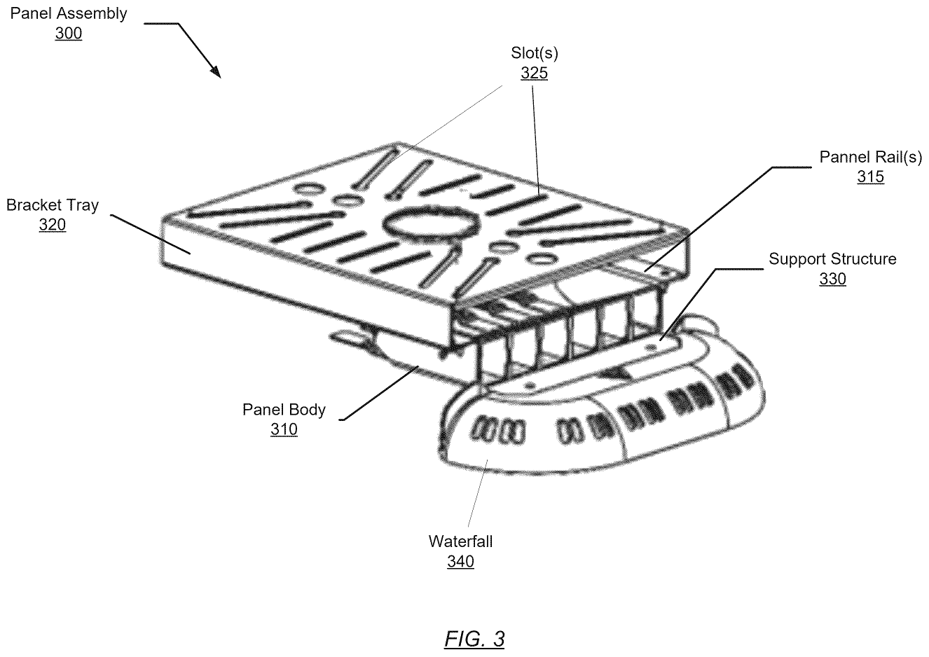

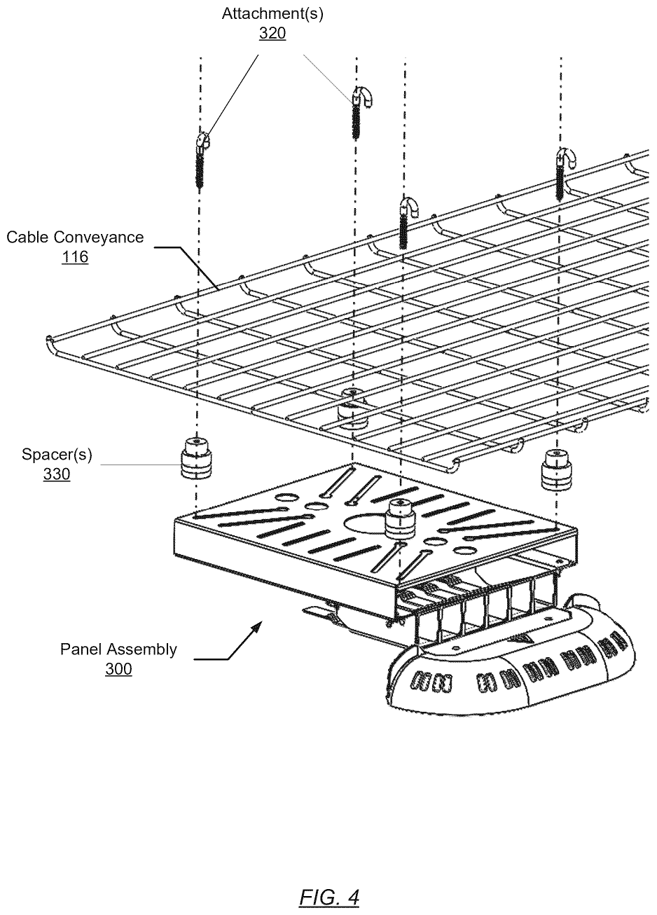

The dividers (212) may be configured in any shape and size. In some embodiments, one or more of the dividers (212) may be configured with a generally triangular shape. In preferred embodiments, one or more of the dividers (212) may comprise a generally right trapezoid shape having two adjacent right angles and two parallel sides as shown in FIGS. 3A and 3C. In other embodiments, one or more of the dividers (212) may comprise a generally square shape, half circle shape, rectangular shape, or any other shape.

The panel(s) (110) may comprise one or more key(s) (220) which may be coupled to, optionally by being integrally formed with, the frame base (210). In some embodiments, a key(s) (220) may be coupled to a frame base (210) so that the key(s) (220) may extend away from an alignment slot (214) of the panel(s) (110). In preferred embodiments, each key(s) (220) may be coupled to a frame base (210) so that each key(s) (220) may extend away from a respective alignment slot (214) of the panel(s) (110). In further preferred embodiments, the panel(s) (110) may comprise a key(s) (220) extending away from each alignment slot (214).

Each key(s) (220) may comprise a key aperture (222) which may be positioned anywhere on the key(s) (220). In some embodiments, all or portions of a key(s) (220) may be movable relative to the frame base (210). In preferred embodiments, the portion of the key(s) (220) having the key aperture (222) may be movable relative to the frame base (210). Optionally, the key(s) (220) and/or frame base (210) may be made from a flexible material, such as a sheet of plastic or metal, which may allow the portion of the key(s) (220) having the key aperture (222) to be movable relative to the frame base (210). In other embodiments, any movable coupling may be used to enable the portion of the key(s) (220) having the key aperture (222) to be movable relative to the frame base (210), such as any type of hinge or movable fastener. By being movable, the key aperture (222) may be moved into and out of contact with a lock tab of a module(s) (112) that is received in a respective alignment slot (214).

In some embodiments, the panel(s) (110) may comprise a face plate (224) which may be coupled to one or more dividers (212), frame base (210), or other element of the panel(s) (110). A face plate (224) may comprise a number of gate(s) (226), in which each gate(s) (226) may form and bound the entrance of an alignment slot (214) opposite the key(s) (220) of the alignment slot (214). In some embodiments, a face plate (224) may comprise one or more, and preferably four securement aperture(s) (228) which may be sized and shaped to receive one or more fasteners, such as screws, bolts, other threaded fasteners, or any other type of fastener, which may be used to secure the panel(s) (110) to rack (100) of FIG. 1.

Each alignment slot (214) may be configured to received one or more module(s) (112). In some embodiments, a module(s) (112) may be secured or coupled to the panel(s) (110) via engagement with a key aperture (222). For example, a module(s) (112) may be secured or coupled to the panel(s) (110) via engagement between a lock tab on the module(s) (112) with a key aperture (222) of a key (220).

The module(s) (112) may secure one or more cables to their respective cable coupling(s) (230) and/or strain relief (232). In some embodiments, a blanking plug (234) may be coupled to module(s) (112) to prevent dirt, contaminants, unwanted access, etc. the module(s) (112) and any cable connectors (230) positioned in the module(s) (112).

FIG. 3 illustrates a panel assembly (300) mounted to a cable conveyance. The panel assembly (300) includes a panel body (310) secured to a bracket tray (320). The bracket tray (320) is attached to a support structure (330) that extends forward from the front edge of the panel body (310) to support a waterfall (340). A plurality of diagonal slots (325) are formed in the bracket tray (320) to receive mounting attachments that couple the assembly to the cable conveyance. The figure depicts the relationship between the structural components of the panel assembly and the manner in which the waterfall is supported in alignment with the panel body.

The panel assembly (300) forms the integrated structure that supports fiber-optic connections and provides attachment to the cable conveyance. The panel assembly includes the bracket tray, panel body, and associated mounting interfaces, which together establish the orientation and mechanical coupling of the assembly relative to the conveyance. The panel assembly maintains a substantially perpendicular alignment with the longitudinal axis of the conveyance and supports the routing of fiber cables entering and exiting the panel body.

The panel body (310) provides the structural housing for fiber-optic modules and connection points. The panel body includes a plurality of openings for receiving connector modules or adapter plates and may include internal routing paths for fiber storage or strain management. The panel body is secured to the bracket tray (320) so that its front edge aligns with the forward extension of the support structure (330). This alignment ensures that the attached waterfall (340) is positioned to receive and guide fiber cables as they exit the panel body.

The bracket tray (320) supports and positions the panel body relative to the cable conveyance. The bracket tray includes the diagonal slots (325) that receive the mounting attachments. These slots allow the panel assembly to be adjusted laterally or diagonally along the conveyance while maintaining the required perpendicular orientation. The bracket tray distributes the mechanical load between the panel body and the support structure and defines the mounting plane of the assembly.

The slots (325) are elongated openings in the bracket tray (320) through which the mounting attachments pass. Each slot defines an adjustable path that enables repositioning of the panel assembly relative to the conveyance. The geometry of the slots permits the attachments to be arranged in symmetrical or asymmetrical configurations. The slot orientation defines the adjustment range and provides flexibility during installation without requiring modification of the conveyance.

The support structure (330) extends from the front edge of the panel body (310) and projects forward to support the waterfall (340). The support structure provides the interface between the panel assembly and the conveyance. It carries the mechanical load of the waterfall and any attached cable management elements. The forward extension of the support structure maintains the alignment of the waterfall relative to the panel body and ensures that exiting fiber cables follow a continuous and supported path.

The panel rails (315) extend along the sides of the panel body (310) to provide rigidity and positional reference for module alignment. The rails also serve as attachment points for coupling the panel body to the bracket tray (320). The rails maintain the spacing and dimensional stability of the panel assembly during installation and operation.

The waterfall (340) is coupled to the forward portion of the support structure (330). The waterfall provides a guided pathway for fiber cables exiting the panel body, maintaining a controlled bend radius and organizing cable flow toward the conveyance. The waterfall may include multiple retention points or surfaces that align with the cable routing geometry defined by the support structure.

FIG. 4 illustrates a panel assembly (300) mounted to a cable conveyance (116) using a plurality of attachments (320) and spacers (330). The panel assembly (300) is positioned beneath the cable conveyance (116) and maintained in a perpendicular orientation relative to the longitudinal axis of the conveyance. The configuration shown provides mechanical separation between the panel assembly and the conveyance through the use of the spacers, which offset the panel assembly to allow for cable access and strain-relief clearance.

The cable conveyance (116) forms the supporting structure to which the panel assembly (300) is mounted. The conveyance may include a ladder rack or basket tray used to route and support fiber-optic cables within a telecommunications environment. The conveyance provides the mechanical reference plane for installation of the panel assembly. The spacing and geometry of the conveyance allow the attachments to engage with the rails, rungs, or wire members that form the structure.

The attachments (320) connect the panel assembly (300) to the cable conveyance (116). Each attachment passes through or interfaces with the diagonal slots of the bracket tray and couples to the conveyance at selected mounting points. The attachments secure the panel assembly in position while allowing limited adjustment along the slot paths. The attachments transfer the load of the panel assembly to the conveyance and maintain a stable connection during service and cable access.

The spacers (330) are positioned between the panel assembly (300) and the cable conveyance (116). Each spacer establishes a defined offset distance that separates the panel assembly from the underside of the conveyance. The spacers provide clearance for the routing of fiber cables between the panel body and the conveyance structure. The use of spacers also facilitates airflow and access to cables entering or exiting the panel body. Each spacer may be engaged with an attachment to form a combined fastener assembly that maintains the offset while supporting the load of the panel assembly. The use of attachments and spacers enables consistent installation geometry and repeatable alignment regardless of the type or spacing of the conveyance members.

The panel assembly (300) includes the bracket tray and panel body described in connection with previous figures. In this configuration, the panel assembly is suspended below the cable conveyance (116), supported by the attachments (320) and spacers (330). The orientation allows fiber-optic cables to enter or exit the panel body while remaining within the vertical envelope of the conveyance, thereby maintaining organized routing and minimizing bend stress.

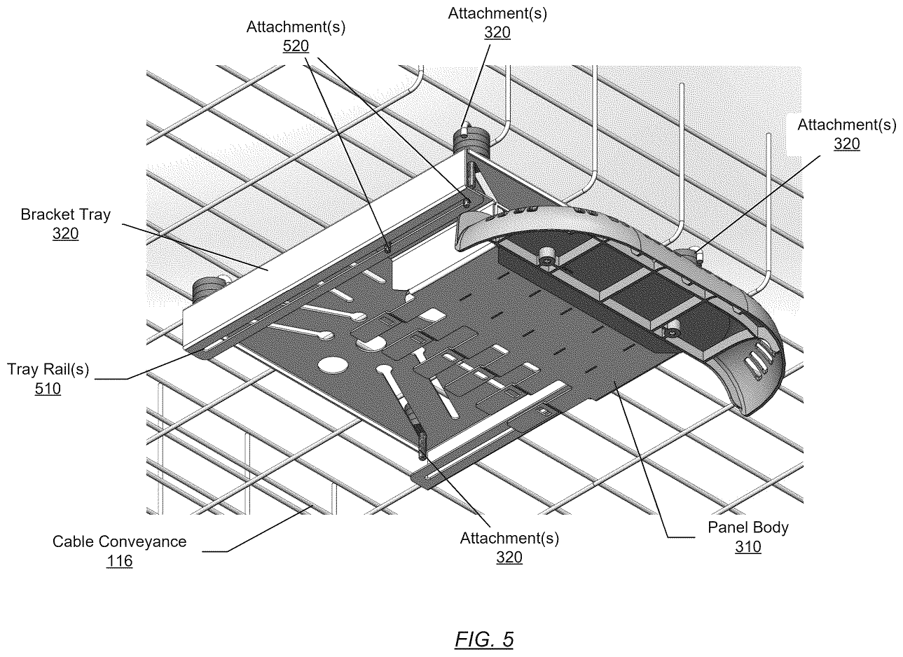

FIG. 5 illustrates the interaction between the bracket tray (320), the tray rails (510), and the panel rails (315) of the panel assembly (300). The configuration shown depicts attachments (320) coupling the bracket tray (320) to the cable conveyance (116), and attachments (520) coupling the tray rails (510) to the panel rails (315). The attachments (520) engage a slot formed within each tray rail (510), permitting the panel body (310) to slide relative to the bracket tray (320) while maintaining its perpendicular orientation with respect to the conveyance.

The tray rails (510) extend along the underside of the cable conveyance (116) and form the intermediate structural interface between the bracket tray (320) and the panel body (310). Each tray rail (510) includes an elongated slot that defines a linear path along which the panel rails (315) may be repositioned. The engagement between the tray rails and the panel rails establishes a guided, controlled sliding motion that allows for positional adjustment of the panel body (310) relative to the bracket tray (320).

The attachments (520) secure the tray rails (510) to the panel rails (315). Each attachment (520) passes through the slot within the tray rail and engages the corresponding panel rail. The configuration allows the panel body (310) to translate along the slot while remaining supported by the bracket tray (320). The attachments maintain the alignment of the panel body with the longitudinal axis of the conveyance and permit adjustment during installation or maintenance without disassembly of the panel assembly.

The attachments (320), previously described, secure the bracket tray (320) to the cable conveyance (116). In this figure, they operate in combination with the attachments (520) to form a two-stage mounting arrangement. The attachments (320) fix the position of the bracket tray relative to the conveyance, while the attachments (520) allow the panel body (310) to slide relative to the tray rails (510). Together, the attachments provide both structural support and positional flexibility of the panel assembly (300).

The interaction between the tray rails (510) and the panel rails (315) allows the panel body (310) to be advanced or retracted along the bracket tray (320) for alignment with adjacent panels or for access to internal fiber-optic connections. The sliding motion defined by the attachments (520) is limited by the length of the slot within the tray rails, ensuring that the panel remains properly supported throughout its range of movement.

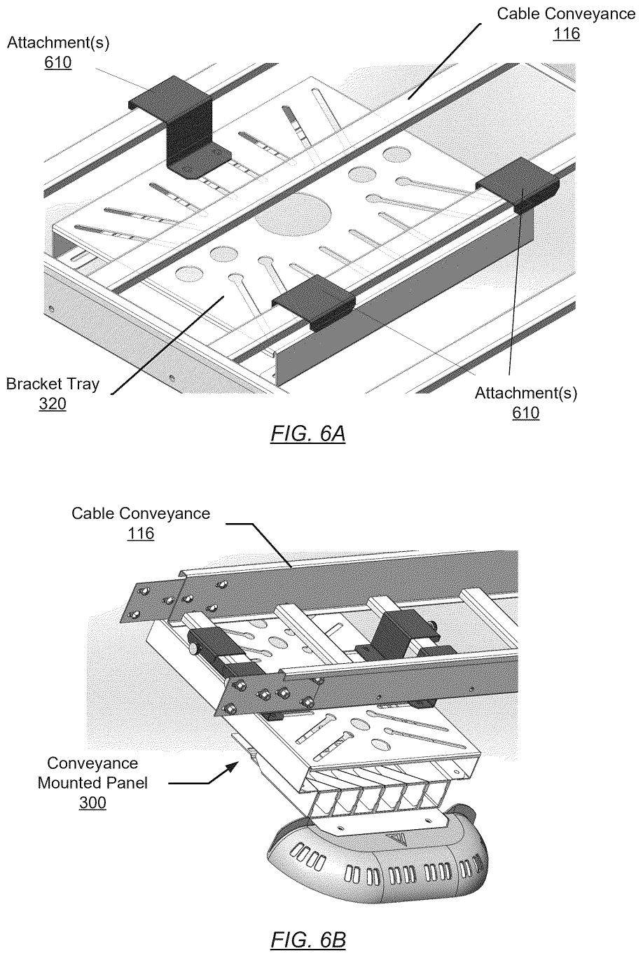

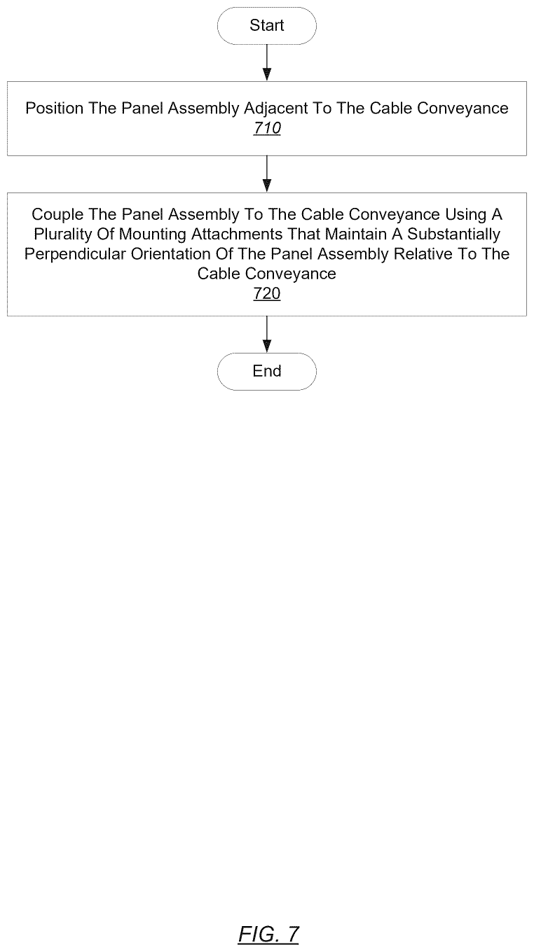

FIG. 6 illustrates alternative attachment configurations for securing the panel assembly (300) to the cable conveyance (116). The figure includes two arrangements, shown in FIGS. 6A and 6B. Both configurations maintain the panel assembly (300) in a perpendicular orientation relative to the conveyance while accommodating variations in installation geometry and conveyance profile.

In FIG. 6A, the attachments (610) engage the upper portion of the bracket tray (320) and connect directly to the structural members of the cable conveyance (116). Each attachment (610) passes through an opening or slot in the bracket tray and engages a corresponding rail or rung of the conveyance. This configuration establishes a direct connection that supports the weight of the panel assembly (300) and positions the bracket tray in close proximity to the underside of the conveyance. The arrangement allows for stable mounting where minimal clearance between the panel and conveyance is desired.

In FIG. 6B, the attachments (610) are positioned along the lower portion of the bracket tray (320), establishing an offset coupling between the panel assembly (300) and the cable conveyance (116). The attachments extend downward and engage the conveyance through a clamping or hooked interface, positioning the bracket tray below the primary structural members of the conveyance. This arrangement creates additional clearance for cable routing between the panel assembly and the conveyance and may be used when cable bend radius or access requirements dictate a lower mounting plane.

The bracket tray (320) interfaces with the attachments (610) in both configurations to support the panel body (310). The tray distributes the load of the panel assembly (300) and aligns the attachments (610) along the same longitudinal axis as the conveyance.

The cable conveyance (116) provides the structural support for both configurations. In each case, the attachments (610) couple to existing conveyance members without requiring modification to the conveyance geometry. The two configurations shown demonstrate how the same bracket tray and panel assembly may be adapted for use with different conveyance structures while maintaining the same alignment and functional relationships among components.

The panel assembly (300) remains suspended beneath the cable conveyance (116) in both arrangements, supported through the bracket tray (320) and attachments (610). The orientation and spacing of the attachments within the bracket tray are selected to maintain uniform load distribution across the panel assembly while permitting lateral or diagonal adjustment during installation.

While FIGS. 1-6 show a configuration of components, other configurations may be used without departing from the scope of one or more embodiments. For example, various components may be combined to create a single component. As another example, the functionality performed by a single component may be performed by two or more components.

FIG. 7 illustrates a flowchart depicting a process for installing a panel assembly to a cable conveyance. The flowchart represents a sequence of operations for positioning and securing the panel assembly in a perpendicular orientation relative to the conveyance using a plurality of mounting attachments. The steps define a generalized installation process that may be applied to ladder rack or basket tray configurations.

At step 710, the panel assembly is positioned adjacent to the cable conveyance. The installer aligns the bracket tray and panel body relative to the longitudinal axis of the conveyance to determine the desired mounting location. The positioning step establishes the clearance and orientation of the panel assembly, ensuring that the panel body will be substantially perpendicular to the conveyance once attached. The placement may vary depending on cable routing, access requirements, and available support structure.

At step 720, the panel assembly is coupled to the cable conveyance using a plurality of mounting attachments. Each attachment engages a corresponding slot within the bracket tray and connects to a structural member of the conveyance, such as a rail, rung, or wire segment. The attachments secure the panel assembly while maintaining its perpendicular orientation relative to the conveyance. The use of multiple attachment points distributes mechanical load and stabilizes the panel assembly during installation.

In some configurations, the installer may slide each attachment along its respective slot to adjust the position of the panel assembly along the conveyance. The slots provide alignment flexibility and allow symmetrical or asymmetrical placement of the panel assembly depending on the cable management layout. This adjustment capability facilitates precise positioning without modification of the conveyance structure.

When the conveyance is a ladder rack, the attachments may include hooks, clips, or clamps that engage the rails or rungs to secure the bracket tray. The engagement method enables tool-assisted or tool-less installation depending on the attachment design. In other configurations, where the conveyance is a basket tray, the attachments may include spacers or standoffs that couple to the wire members of the tray to create clearance between the panel assembly and the conveyance.

The installation process may include rotation or adjustment of one or more attachments by loosening a fastener within the diagonal slot of the bracket tray. This allows the angle or offset of the panel assembly to be modified to achieve proper alignment. The single-bolt interface of each attachment facilitates fine-tuning of the panel assembly position without disassembly.

A strain-relief feature may be installed along an edge of the panel assembly following attachment to the conveyance. Fiber cables are routed over the strain-relief feature to maintain a controlled bend radius and to organize cable transitions between the panel body and the conveyance. This final step ensures that mechanical stress on the cables is minimized and that the routing complies with bend-radius requirements of the fiber system.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. An apparatus comprising:
a panel assembly configured to support one or more fiber-optic modules;
a plurality of mounting attachments configured to couple the panel body to a cable conveyance, maintaining a substantially perpendicular orientation of the panel body relative to a cable conveyance.

2. The apparatus of claim 1, wherein the panel assembly further comprises:
a bracket tray that couples to the cable conveyance; and
a panel body that couples to the bracket tray and includes multiple module openings configured to receive fiber-optic connector modules or adapter plates.

3. The apparatus of claim 1, wherein each mounting attachment is slidable along a respective diagonal slot in the bracket tray, wherein the diagonal slots are positioned on opposing sides of the panel assembly to permit symmetrical or asymmetrical positioning of the mounting attachments.

4. The apparatus of claim 1, wherein each mounting attachment includes a hook, clip, or clamp configured to engage a rung or rail of a ladder rack.

5. The apparatus of claim 1, wherein each mounting attachment includes a spacer or standoff configured to couple the panel assembly to one or more wire members of a basket tray.

6. The apparatus of claim 1, wherein each mounting attachment includes a single-bolt fastener enabling rotation or positional adjustment of the mounting attachment within a diagonal slot.

7. The apparatus of claim 1, further comprising a strain-relief feature coupled to an edge of the panel assembly to guide and support fiber cables exiting the panel body.

8. A cable-management system comprising:
a cable conveyance configured to route a plurality of fiber-optic cables; and
a panel assembly secured to the cable conveyance by a plurality of mounting attachments that maintain a substantially perpendicular orientation of the panel assembly relative to the cable conveyance.

9. The system of claim 8, wherein the panel assembly comprises:
a bracket tray coupled to the cable conveyance; and
a panel body coupled to the bracket tray, the panel body including multiple module openings configured to receive fiber-optic connector modules or adapter plates.

10. The system of claim 8, wherein each mounting attachment is slidable along a respective diagonal slot in the bracket tray, and the diagonal slots are positioned on opposing sides of the panel assembly to permit symmetrical or asymmetrical positioning of the mounting attachments.

11. The system of claim 8, wherein each mounting attachment includes a hook, clip, or clamp configured to engage a rung or rail of a ladder rack.

12. The system of claim 8, wherein each mounting attachment includes a spacer or standoff configured to couple the panel assembly to one or more wire members of a basket tray.

13. The system of claim 8, wherein each mounting attachment includes a single-bolt fastener enabling rotation or positional adjustment of the mounting attachment within a diagonal slot.

14. The system of claim 8, further comprising a strain-relief feature coupled to an edge of the panel assembly to guide and support fiber-optic cables exiting the panel body.

15. A method for installing a panel assembly to a cable conveyance, comprising:
positioning the panel assembly adjacent to the cable conveyance; and
coupling the panel assembly to the cable conveyance using a plurality of mounting attachments that maintain a substantially perpendicular orientation of the panel assembly relative to the cable conveyance.

16. The method of claim 15, wherein coupling the panel assembly to the cable conveyance comprises:
attaching a bracket tray of the panel assembly to the cable conveyance and coupling a panel body of the panel assembly to the bracket tray, the panel body including multiple module openings configured to receive fiber-optic connector modules or adapter plates.

17. The method of claim 15, further comprising:
sliding each mounting attachment along a corresponding diagonal slot in the bracket tray to position the panel assembly symmetrically or asymmetrically relative to the cable conveyance.

18. The method of claim 15, wherein the cable conveyance comprises a ladder rack, and coupling the panel assembly further comprises:
engaging each mounting attachment to a rung or rail of the ladder rack.

19. The method of claim 15, wherein the cable conveyance comprises a basket tray, and coupling the panel assembly further comprises:
securing each mounting attachment to one or more wire members of the basket tray using a spacer or standoff.

20. The method of claim 15, further comprising:
attaching a strain-relief feature to an edge of the panel assembly; and
routing fiber-optic cables across the strain-relief feature to maintain a controlled bend radius.
